(19) United States
(12) Patent Application Publication
(10) Pub. No.: US 2009/0257469 A1
(43) Pub. Date: Oct. 15, 2009

(54) INFRARED THERMOMETER

(76) Inventors: Mike N. Jones, Lake Forest Park, WA (US); Evans H. Nguyen, Renton, WA (US); Scott D. Bublitz, Hartland, WI (US); Jason R. Crowe, Milwaukee, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/421,455

(22) Filed: Apr. 9, 2009

Related U.S. Application Data
(63) Continuation-in-part of application No. 12/399,835, filed on Mar. 6, 2009.
(60) Provisional application No. 61/043,449, filed on Apr. 9, 2008.
(60) Provisional application No. 61/095,038, filed on Sep. 8, 2008.

(51) Int. Cl. G01K 1/00; G01J 5/04

(52) U.S. Cl. 374/133; 374/208; 374/E01.001

(57) ABSTRACT

The invention relates to an infrared (“IR”) thermometer that includes a pistol-grip handle which is operable to receive a high-voltage removable and rechargeable battery pack. In one embodiment, the thermometer includes a main body, a handle portion, a trigger, a display, a control section, an LED flashlight, a plurality of sensors, and a high-voltage removable and rechargeable battery pack. The handle forms an oblique angle with respect to the main body and includes a first recess for receiving the battery pack. The trigger is operable to initiate a temperature measurement, and the display is operable to display, among other things, a measured temperature. The plurality of sensors include, for example, an IR temperature sensor, a thermocouple, a humidity sensor, and an ambient temperature sensor.

### RELATED APPLICATIONS

This application is a continuation-in-part of prior filed co-pending U.S. patent application Ser. No. 12/399,835, filed Mar. 6, 2009, the entire contents of which are hereby incorporated by reference. This application also claims the benefit of prior filed co-pending U.S. provisional patent application Ser. No. 61/043,449, filed on Apr. 9, 2008, and Ser. No. 61/095,038, filed on Sep. 8, 2008, the entire contents of which are both hereby incorporated by reference.

### BACKGROUND

This invention relates to an infrared (“IR”) thermometer. IR thermometers are powered by replaceable or rechargeable alkaline batteries. For example, IR thermometers often include a battery receiving area that is adapted to receive a plurality (e.g., 2, 3, 4, etc.) of alkaline batteries. The batteries are secured in the receiving area via a removable door, cap, or plate which is fixedly attached to the device's housing. The alkaline batteries, which typically have a nominal voltage of 1.5V, are connected in series to provide operational power to the thermometer.

### SUMMARY

Embodiments of the invention relate to an infrared (“IR”) thermometer that includes a pistol-grip handle which is operable to receive a high-voltage removable and rechargeable battery pack. In one embodiment, the thermometer includes a main body, a handle portion, a trigger, a display, a control section, an LED flashlight, a plurality of sensors, and the battery pack. The handle forms an oblique angle with respect to the main body and includes a first recess for receiving the battery pack. The trigger is operable to initiate a temperature measurement, and the display is operable to display, among other things, a measured temperature. The control section includes a plurality of buttons which are operable to control or set a plurality of functions and values associated with the thermometer. The plurality of sensors include, for example, an IR temperature sensor, a contact temperature sensor, a humidity sensor, and an ambient temperature sensor.

In one embodiment, the invention provides an infrared thermometer capable of receiving a removable and rechargeable battery pack. The thermometer includes a main body having a first axis, a handle having a second axis, an infrared temperature sensor, a contact temperature sensor, and a display. The handle includes a first recess that is configured to receive the battery pack and at least first and second electrical terminals which are exposed when the battery pack is not inserted into the first recess. The battery pack is inserted into the first recess along the second axis, and the second axis forms an oblique angle with the first axis. The infrared temperature sensor is operable to sense a first temperature of a first area in a non-contact manner, the contact temperature sensor is operable to sense a second temperature of a second area in a contact manner, and the display is configured to display an indication of the first temperature and the second temperature.

In another embodiment, the invention provides a method of operating an infrared thermometer that includes a handle portion, an infrared temperature sensor, a contact temperature sensor, and a humidity sensor. The method includes powering the infrared thermometer with a removable battery pack inserted into a receiving chamber of the handle portion. The method also includes sensing a first temperature of a first area using the infrared temperature sensor, sensing a second temperature of a second area using the contact temperature sensor, and sensing a first humidity using the humidity sensor. The first temperature, the second temperature, and the first humidity are compensated using an output of an ambient temperature sensor, and displayed on a display.

Other aspects of the invention will become apparent by consideration of the detailed description and accompanying drawings.

### BRIEF DESCRIPTION OF THE DRAWINGS

FIG. 1 is a rear perspective view of an infrared (“IR”) thermometer according to an embodiment of the invention.

FIG. 2 is a front view of the IR thermometer of FIG. 1.

FIG. 3 is a right side view of the IR thermometer of FIG. 1.

FIG. 4 is a left side view of the IR thermometer of FIG. 1.

FIG. 5 is a rear view of the IR thermometer of FIG. 1.

FIG. 6 is a top view of the IR thermometer of FIG. 1.

FIG. 7 is a bottom view of the IR thermometer of FIG. 1.

FIG. 8 illustrates a control section of the IR thermometer of FIG. 1.

FIG. 9 is an exploded view of the IR thermometer of FIG. 1.

FIG. 10 is a perspective view of a battery pack.

FIG. 11 is an exploded view of the battery pack of FIG. 10.

FIG. 12 is a top view of the battery pack of FIG. 10.

FIG. 13 is a block diagram of an IR thermometer according to an embodiment of the invention.

FIG. 14 illustrates a process for operating an IR thermometer according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Infrared (“IR”) thermometers are generally lightweight and low-power consumption devices which are powered by one or more alkaline batteries. Removable and rechargeable batteries (e.g., nickel-cadmium (“NiCd”) or nickel-metal hydride (“NiMH”) batteries), such as those used in power tools, cannot reasonably be used with IR thermometers because of the batteries' size and weight. However, lithium-ion battery packs enable the use of high-voltage removable and rechargeable battery packs with IR thermometers.

As a result of receiving operational power from a battery pack with a lithium-based chemistry, a thermometer is capable of including a variety of features or functions in addition to non-contact temperature sensing which demand increased power. For example, the thermometer can include a high-intensity LED flashlight, a backlighted control section or actuators, a contact temperature sensor, a humidity sensor, an ambient temperature sensor, a high-resolution LCD, a color LCD, and/or an additional or remote display. Thermometers powered by alkaline batteries are either unable to provide the required voltage and current to power these additional features, or the operational runtime (i.e., the amount of time for which the batteries can power the thermometer before the batteries need to be replaced or recharged) of the alkaline batteries is shortened. In contrast, the lithium-based battery packs are capable of powering the additional features of the IR thermometer as well as the traditional features and functions, while maintaining an operational runtime that is comparable to or longer than an IR thermometer that does not include additional features.

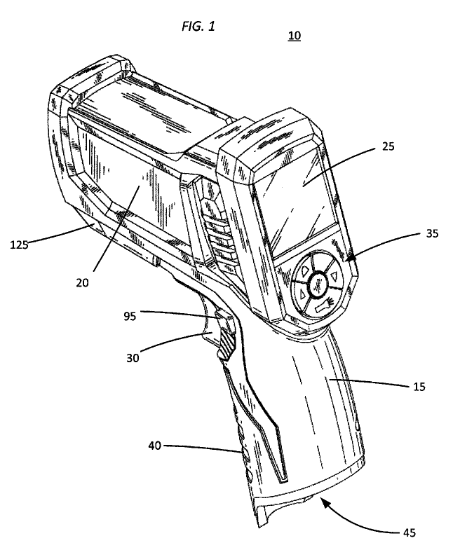

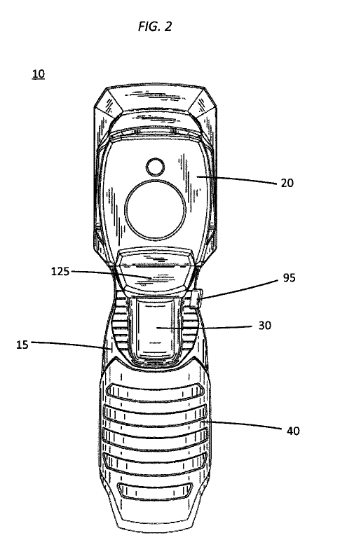

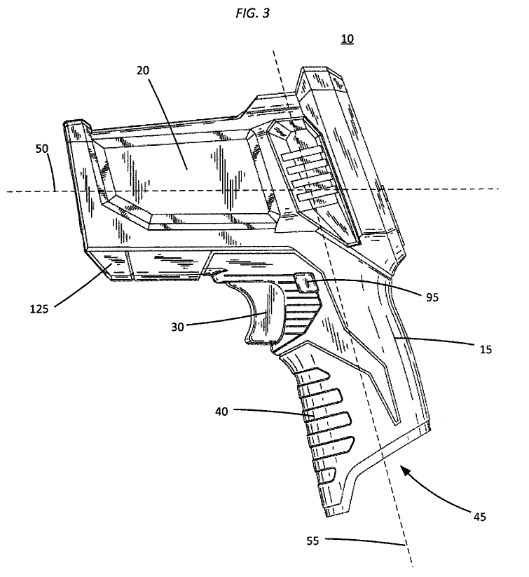

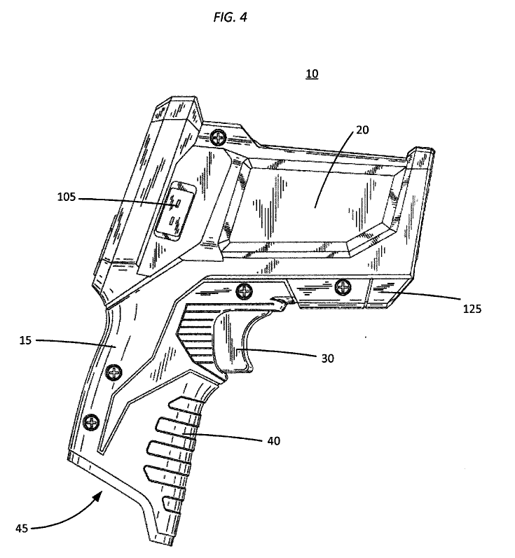

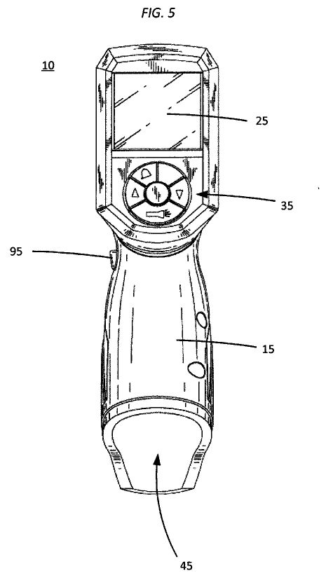

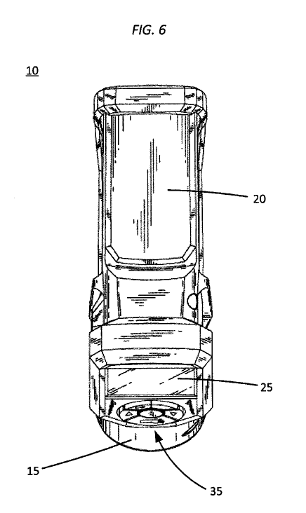

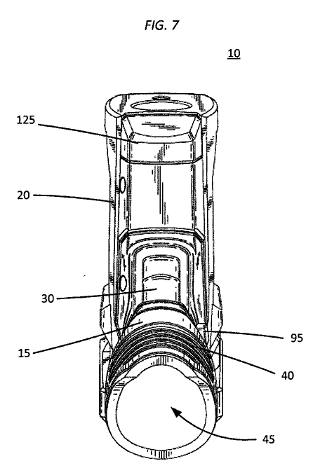

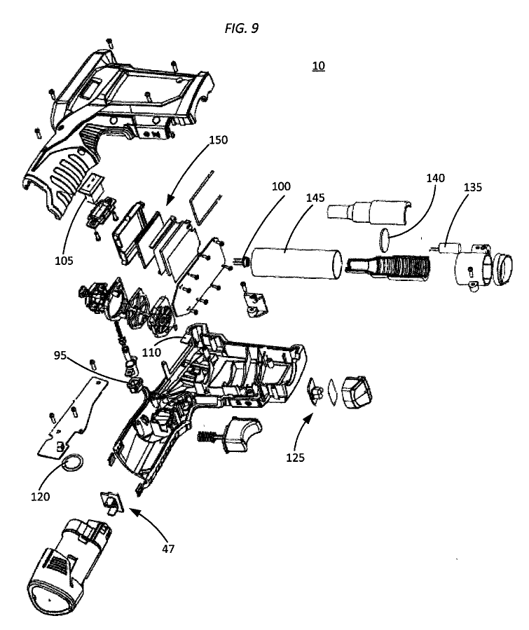

FIGS. 1-7 illustrate an IR thermometer 10 that includes, among other things, a handle 15, a main body 20, an embedded display 25, a control device or trigger 30, a control section 35, a grip portion 40, and a high-voltage removable and rechargeable battery pack (described below). The handle 15 is a pistol-grip handle and includes at least one recess 45. The handle 15 includes, for example, a first half and a second half which are fixedly attached to one another in, for example, a clamshell configuration. The first half and the second half of the handle 15 form the at least one recess 45 when coupled to one another. In other embodiments, the handle 15 is molded as a single piece. The recess 45 is, for example, a battery receiving chamber and includes rails or a mating groove (not shown) for slidably receiving a battery pack. The recess 45 includes terminals 47 (see FIG. 9) for mating with corresponding terminals on the battery pack. The terminals 47 are exposed when the battery pack is not inserted into the recess 45. The handle 15 is further configured to ergonomically conform to the shape of a user's hand (right or left) such that the thermometer 10 can be held and operated using a single hand and without the user having to divert his or her line-of-sight, as described below.

The handle 15 is configured to offset a holding position of the thermometer 10 to align the display 25, the trigger 30, and the operation of the thermometer 10 with a line-of-sight of a user or a first axis 50. The handle 15 is attached to a lower portion of a main body 20 along a second axis 55 such that the handle 15 is at an oblique angle with respect to the first axis 50. In other embodiments, the handle 15 is approximately perpendicular to the first axis 50. The battery pack is inserted into the recess 45 and along the second axis 55 of the handle 15 to provide power to the thermometer 10.

The display 25 is attached to a rear portion of the main body 20 along the first axis 50. The user's line-of-sight is aligned with or parallel to the first axis 50. In the illustrated embodiment, the display 25 is a liquid crystal display (“LCD”), such as a negative LCD (“NLCD”) with an electroluminescent backlight, but may alternatively be another suitable type of display. The negative LCD includes lighted symbols, such as white alphanumeric symbols, on a black background. The NCLD improves the visibility of the display 25 in low or poor lighting conditions, such as outdoor, dark, or dirty conditions. In some embodiments, the display 25 is at an offset angle with respect to the first axis 50 to improve the visibility of the display 25. The display 25 also includes a screen timeout period which is either preprogrammed or set by the user. If the screen timeout period is reached or lapses and no buttons in the control section 35 are actuated and/or no measurements are taken, the display 25 enters a standby or power saving mode to conserve power.

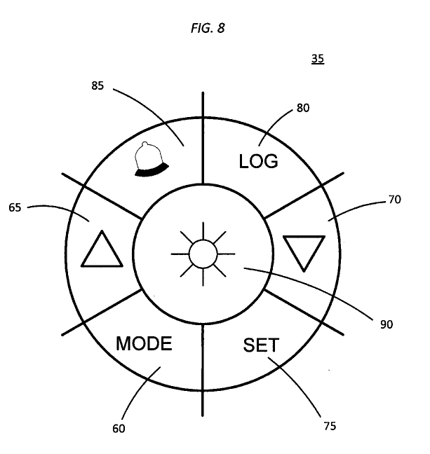

The control section 35 is illustrated in FIG. 8. The control section 35 is positioned proximate to the display 25 and includes a plurality of control buttons. The position and configuration of the control buttons allow the thermometer 10 to be controlled without the user having to divert his or her line-of-sight from display 25 or the operation of the thermometer 10. For example, in the illustrated embodiment, the control section 35 is positioned below the display 25. The control section 35 includes a mode button 60, an up button 65, a down button 70, a settings button 75, a log save button 80, an alarm button 85, and a flashlight button 90. The mode button 60 is actuated to select an operational mode from, for example, a menu or a predetermined set of operational modes. For example, the mode button 60 allows a user to scroll through a plurality of operational modes, such as an average temperature mode, a maximum temperature mode, a minimum temperature mode, a humidity mode, a dew point mode, a wet bulb mode, and a contact temperature mode. In some embodiments, the mode button 60 is repeatedly selected to cycle through the operational modes of the thermometer 10. In other embodiments, the mode button 60 is pressed once, and the up and down buttons 65 and 70 are used to scroll through thermometer 10 modes. The selected operational mode determines the information that is displayed on the display 25. As such, in some embodiments, the thermometer 10 is a menu-driven device. In some embodiments, the thermometer 10 also includes one or more LEDs for providing an indication to the user of the status or operational mode of the thermometer 10, the battery pack, or both.

Additional control buttons can be located on the handle 15 and/or the main body 20. For example, an electronic trigger lock button 95 is located on the handle 15 and enables the thermometer 10 to take a continuous non-contact temperature reading without the trigger 30 being engaged. In some embodiments, the thermometer 10 takes the non-contact temperature reading until the user engages the trigger 30 a second time. In other embodiments, the continuous reading is taken until the trigger lock button 95 is deactivated, or a predetermined time limit (e.g., 20 minutes) has elapsed.

If the thermometer 10 is operating in the average temperature mode, an indication that the thermometer 10 is operating in the average temperature mode is displayed on the display 25. In one embodiment, the letters “AVG” are displayed. When operating in the average temperature mode, the average temperature during the course of a single temperature reading (e.g., the time during which the trigger 30 is pressed) is also displayed on the display 25. If the thermometer 10 is operating in the maximum temperature mode, an indication that the thermometer 10 is operating in the maximum temperature mode is displayed on the display 25. In one embodiment, the letters “MAX” are displayed. When operating in the maximum temperature mode, the maximum temperature reading during the course of a single temperature reading is also displayed. If the thermometer 10 is operating in the minimum temperature mode, an indication that the thermometer 10 is operating in the minimum temperature mode is displayed on the display 25. In one embodiment, the letters “MIN” are displayed. When operating in the minimum temperature mode, the minimum temperature reading during the course of a single temperature reading is also displayed on the display 25. If the thermometer 10 is operating in the humidity mode, an indication that the thermometer 10 is operating in the humidity mode is displayed on the display 25. In one embodiment, the letters “HUM” are displayed, as well as an indication that a relative humidity measurement is being displayed (e.g., “RH %”). When operating in the humidity mode, a three-digit relative humidity (e.g., 96.3) is displayed. If the thermometer 10 is operating in the dew point mode, an indication that the thermometer 10 is operating in the dew point mode is displayed on the display 25. In one embodiment, the letters “DEW” and a calculated dew point are displayed. If the thermometer 10 is in the wet bulb mode, an indication that the thermometer 10 is operating in the wet bulb mode is displayed. In one embodiment, the letters “WET” and a wet bulb calculation are displayed. If the thermometer 10 is operating in the contact temperature mode, an indication that the thermometer 10 is operating in the contact temperature mode is displayed. In one embodiment, the letters “CON” and a contact temperature measurement are displayed on the display 25.

The settings button 75 is operable to set or modify various thresholds and functions of the thermometer 10. For example, the settings button 75 is actuated to scroll through the thresholds and functions which the user can control. For example, the settings button 75 allows a user to set a high temperature alarm threshold, a low temperature alarm threshold, a log reading, an emissivity, and temperature measurement units (e.g., Fahrenheit or Celsius), and turn a laser (see FIG. 9) on and off. In some embodiments, the settings button 75 is repeatedly actuated to cycle through the thresholds and functions. In other embodiments, the settings button 75 is actuated once, and the up and down buttons 65 and 70 are used to scroll through thermometer thresholds and functions.

When setting the high temperature alarm threshold, the user actuates the settings button 75 until the letters “HI” appear on the display 25. The user adjusts the high temperature alarm threshold using the up and down buttons 65 and 70. The alarm is activated when the non-contact temperature reading is above the high temperature alarm threshold. When setting the low temperature alarm threshold, the user actuates the settings button 75 until the letters “LOW” appear on the display 25. The user adjusts the low temperature alarm threshold using the up and down buttons 65 and 70. The alarm is activated when the non-contact temperature reading is below the low temperature alarm threshold. The alarm is toggled on and off using the alarm button 85. When setting a log value, the user actuates the settings button 75 until the letters “LOG” appear on the display 25. The thermometer 10 also displays a number (e.g., between 1 and 20) which indicates a log value memory location. For example, if a log value was previously saved to a log value memory location, the previously saved log value is displayed. The user can scroll through the saved log values using the up and down buttons 65 and 70. The user can overwrite the previously saved log value by actuating the log save button 80 when a particular log value memory location is displayed. The user sets the emissivity of the thermometer 10 by actuating the settings button 75 until the symbol, ε, is displayed. The user adjusts the emissivity level using the up and down buttons 65 and 70. The user toggles the laser on and off by actuating the settings button 75 until a laser symbol (e.g., a class two laser safety symbol) is displayed, and using the up and down buttons 65 and 70 to selectively activate and deactivate the laser.

FIG. 9 illustrates an exploded view of the IR thermometer 10. The thermometer 10 includes, among other things, the trigger lock button 95, an IR temperature sensor 100, a contact temperature sensor port 105, a humidity sensor 110, a buzzer 120, an LED flashlight 125, a laser module 135, a convex lens 140, a cylindrical aluminum tube 145, and an LCD assembly 150. The flashlight 125 is toggled on and off using the flashlight button 90 in the control section 35. The flashlight 125 can include an incandescent light bulb, a plurality of light emitting diodes, or the like. In one embodiment, the LED flashlight 125 includes three high-intensity LEDs and has an output of, for example, 250 LUX at a distance of two feet. In some embodiments of the invention, the output of the LED flashlight 125 is greater than 250 LUX at a distance of two feet. In some embodiments, the LED flashlight 125 is integral to or detachable from the thermometer 10. In such embodiments, the flashlight 125 includes a secondary power source that is charged or otherwise receives power from the battery pack. The LED flashlight 125 also includes a flashlight timeout period. The flashlight timeout period can have a preprogrammed value or be set by the user. If the flashlight timeout period is reached or lapses and the LED flashlight 125 has not been turned off, the thermometer 10 turns off the LED flashlight 125 to conserve power.

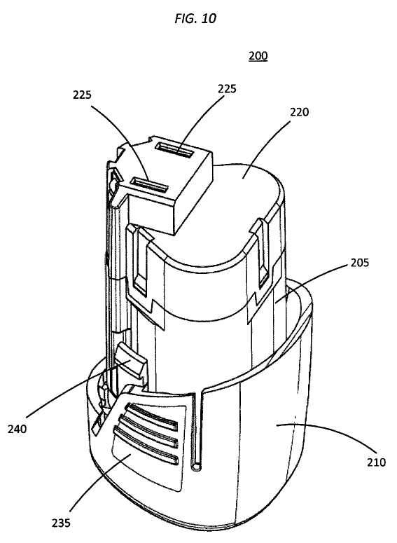

An embodiment of a lithium-based battery pack 200 for powering the thermometer 10 is illustrated in FIGS. 10-12. In the illustrated embodiment, the battery pack 200 includes battery cells having a lithium-based chemistry such that the battery pack 200 is over 65% lighter and 50% smaller than an equivalent nickel-cadmium (“NiCd”) battery pack. The battery pack 200 also provides a longer operational run-time for the thermometer 10, and a longer life (e.g., number of recharge cycles) than the other non-lithium based battery packs.

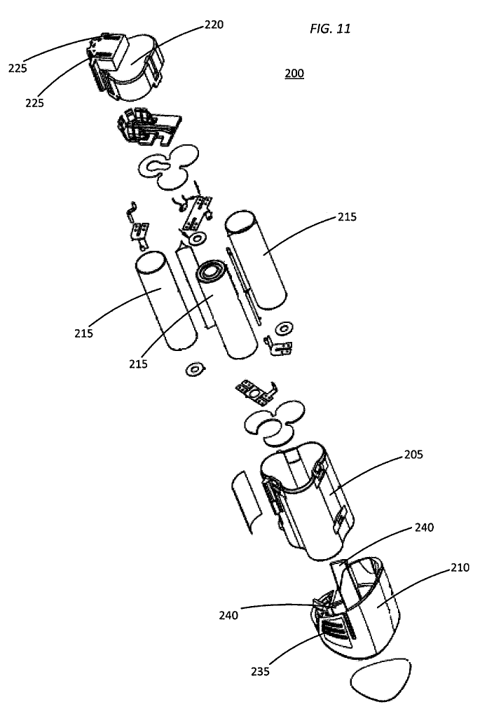

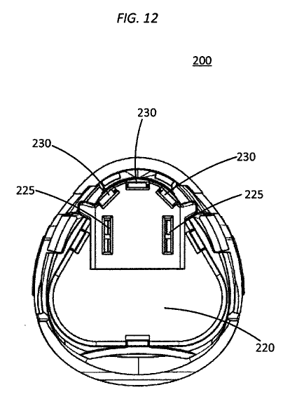

The illustrated battery pack 200 includes a casing 205, an outer housing 210 coupled to the casing 205, and a plurality of battery cells 215 (see FIG. 11) positioned within the casing 205. The casing 205 is shaped and sized to fit within the recess 45 in the thermometer 10 to connect the battery pack 200 to the thermometer 10. The casing 205 includes an end cap 220 to substantially enclose the battery cells 215 within the casing 205. The illustrated end cap 220 includes two power terminals 225 configured to mate with the terminals 47 of the thermometer 10. In other embodiments, the end cap 220 may include terminals that extend from the battery pack 200 and are configured to be received in receptacles supported by the thermometer 10. The end cap 220 also includes sense or communication terminals 230 (see FIG. 12) that are configured to mate with corresponding terminals from the thermometer 10. The communication terminals 230 couple to a battery circuit (not shown). The battery circuit can be configured to monitor various aspects of the battery pack 200, such as pack temperature, pack and/or cell state of charge, etc., and can also be configured to send and/or receive information and/or commands to and/or from the thermometer 10. In one embodiment, the battery circuit operates as illustrated and described in U.S. Pat. No. 7,157,882 entitled “METHOD AND SYSTEM FOR BATTERY PROTECTION EMPLOYING A SELECTIVELY-ACTUATED SWITCH,” issued Jan. 2, 2007, the entire contents of which are hereby incorporated by reference. In another embodiment, the battery circuit operates as illustrated and described in U.S. Patent Publication No. 2006/0091858 entitled “METHOD AND SYSTEM FOR BATTERY PROTECTION,” filed May 24, 2005, the entire contents of which are also hereby incorporated by reference.

The casing 205 and power terminals 225 substantially enclose and cover the terminals 47 of the thermometer 10 when the battery pack 200 is positioned in the recess 45. That is, the battery pack 200 functions as a cover for the recess 45 and terminals 47 of the thermometer 10. Once the battery pack 200 is disconnected from the thermometer 10 and the casing is removed from the recess 45, the terminals 47 on the thermometer 10 are generally exposed to the surrounding environment.

The outer housing 210 is coupled to an end of the casing substantially opposite the end cap 220 and surrounds a portion of the casing 205. In the illustrated construction, when the casing 205 is inserted into or positioned within the recess 45 in the thermometer 10, the outer housing 210 generally aligns with an outer surface of the thermometer 10. In this construction, the outer housing 210 is designed to substantially follow the contours of the thermometer 10 to match the general shape of the handle 15. In such embodiments, the outer housing 210 generally increases (e.g., extends) the length of the handle 15 of the thermometer 10.

In the illustrated embodiment, two actuators 235 (only one of which is shown) and two tabs 240 are formed in the outer housing 210 of the battery pack 200. The actuators 235 and the tabs 240 define a coupling mechanism for releasably securing the battery pack 200 to the thermometer 10. Each tab 240 engages a corresponding recess formed in the thermometer to secure the battery pack 200 in place. The tabs 240 are normally biased away from the casing 205 (i.e., away from each other) due to the resiliency of the material forming the outer housing 210. Actuating (e.g., depressing) the actuators 235 moves the tabs 240 toward the casing 205 (i.e., toward each other) and out of engagement with the recesses such that the battery pack 200 may be pulled out of the recess 45 and away from the thermometer 10. In other embodiments, the battery pack 200 may include other suitable coupling mechanisms to releasably secure the battery pack 200 to the thermometer 10, as discussed below.

As shown in FIG. 11, the battery pack 200 includes three battery cells 215 positioned within the casing 205 and electrically coupled to the terminals 225. The battery cells 215 provide operational power (e.g., DC power) to the thermometer 10. In the illustrated embodiment, the battery cells 215 are arranged in series, and each battery cell 215 has a nominal voltage of approximately four-volts (“4.0V”), such that the battery pack 200 has a nominal voltage of approximately twelve-volts (“12V”). The cells 215 also have a capacity rating of approximately 1.4 Ah. In other embodiments, the battery pack 200 may include more or fewer battery cells 215, and the cells 215 can be arranged in series, parallel, or a serial and parallel combination. For example, the battery pack 200 can include a total of six battery cells 215 in a parallel arrangement of two sets of three series-connected cells. The series-parallel combination of battery cells 215 creates a battery pack 200 having a nominal voltage of approximately 12V and a capacity rating of approximately 2.8 Ah. In other embodiments, the battery cells 215 may have different nominal voltages, such as, for example, 3.6V, 3.8V, 4.2V, etc., and/or may have different capacity ratings, such as, for example, 1.2 Ah, 1.3 Ah, 2.0 Ah, 2.4 Ah, 2.6 Ah, 3.0 Ah, etc. In other embodiments, the battery pack 200 can have a different nominal voltage, such as, for example, 10.8V, 14.4V, etc. In the illustrated embodiment, the battery cells 215 are lithium-ion battery cells having a chemistry of, for example, lithium-cobalt (“Li—Co”), lithium-manganese (“Li—Mn”), or Li—Mn spinel. In other embodiments, the battery cells 215 may have other suitable lithium or lithium-based chemistries.

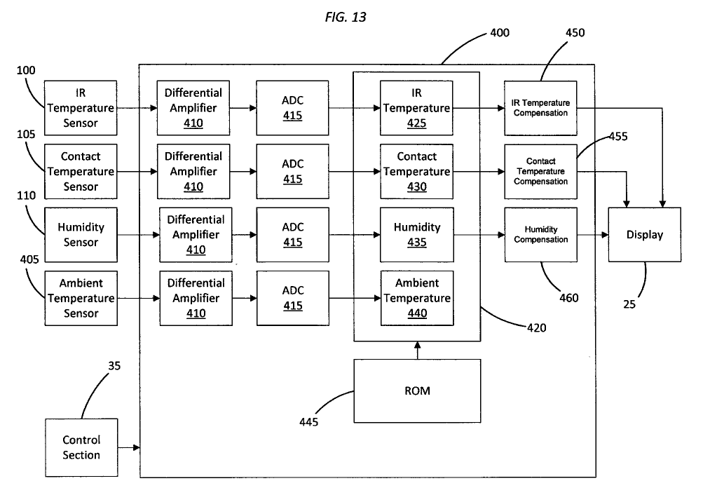

FIG. 13 is a block diagram of the IR thermometer 10. The thermometer 10 includes a thermometer controller 400, the IR temperature sensor 100, the contact temperature sensor port 105, the humidity sensor 110, an ambient temperature sensor 405, the control section 35, and the display 25. The controller 400 includes a plurality of differential amplifiers 410, a plurality of analog-to-digital converters (“ADCs”) 415, a processing module 420, an IR temperature output 425, a contact temperature output 430, a humidity output 435, an ambient temperature output 440, a memory module 445, an IR temperature compensation module 450, a contact temperature compensation module 455, and a humidity compensation module 460. In some embodiments, the ADCs 415 are 24-bit high precision delta-sigma ADCs. The thermometer controller 400 also includes, for example, at least one printed circuit board (“PCB”). The PCB is populated with a plurality of electrical and electronic components which provide power, operational control, and protection to the thermometer 10. In some embodiments, the PCB includes the processing module 420 which is, for example, a microprocessor. The controller 400 also includes a bus for connecting the various components and modules located within or connected to the controller 400. The memory module 445 includes, in some embodiments, read only memory (“ROM”), such as electronically erasable programmable ROM (“EEPROM”), and random access memory (“RAM”). The controller 400 also includes an input/output system that includes routines for transferring information between components and modules within the controller 400. Software included in the implementation of the thermometer 10 is stored in the ROM or RAM of the controller 400. The software includes, for example, firmware applications and other executable instructions. The IR temperature compensation module 450 and the contact temperature compensation module 455 use output signals from the humidity sensor 110 or ambient temperature sensor 405 to compensate temperature measurements and generate compensated IR temperature output and a compensated contact temperature output. The humidity compensation module 460 uses an output from the ambient temperature sensor 405 to compensate humidity measurements and generate compensated humidity outputs. In other embodiments, the controller 400 can include additional, fewer, or different components.

The PCB also includes, for example, a plurality of additional passive and active components such as resistors, capacitors, inductors, integrated circuits, and amplifiers. These components are arranged and connected to provide a plurality of electrical functions to the PCB including, among other things, sensing, filtering, signal conditioning, and voltage regulation. For descriptive purposes, the PCB and the electrical components populated on the PCB are collectively referred to herein as “the controller” 400. The controller 400 receives signals from the IR temperature sensor 100, the contact temperature sensor port 105, the humidity sensor 110, and the ambient temperature sensor 405; processes or conditions the signals; and transmits the processed and conditioned signals to the display 25. In some embodiments, the IR temperature sensor 100, the contact temperature sensor port 105, and the humidity sensor 110 are calibrated or recalibrated using the ambient temperature signal. The display 25 receives the processed and conditioned signals and displays an indication of an IR temperature measurement, a contact temperature measurement, a humidity, a dew point, or the like to the user.

In some embodiments, a battery pack controller (not shown) provides information to the thermometer controller 400 related to a battery pack temperature or voltage level. The thermometer controller 400 and the battery pack also include low voltage monitors and state-of-charge monitors. The monitors are used by the thermometer controller 400 or the battery pack controller to determine whether the battery pack 200 is experiencing a low voltage condition, which may prevent proper operation of the thermometer 10, or if the battery pack is in a state-of-charge that makes the battery pack susceptible to being damaged. If such a low voltage condition or state-of-charge exists, the thermometer 10 is shut down or the battery pack 200 is otherwise prevented from further discharging current to prevent the battery pack from becoming further depleted.

The IR temperature sensor 100 is, for example, a thermopile. The thermopile includes a plurality of thermoelements (e.g., thermocouples) connected in series to form a sensing area or detector, and the sensing area is covered with an IR-absorbing material. A lens focuses infrared energy onto the detector, and the thermopile outputs a signal which is directly proportional to the power of the infrared radiation incident upon the detector. In some embodiments, the IR temperature sensor 100 is operable to sense temperatures in the range of, for example, =30° C. (−22° F.) to 800° C. (1472° F.). The contact temperature sensor port 105 is, for example, a thermocouple port and is operable to receive a thermocouple, such as a K-type thermocouple. The combination of the thermocouple and the thermocouple port are referred to herein as the thermocouple 105. The thermocouple 105 includes two metallic elements (e.g., a hot junction and a cold junction) which provide differing output voltages. The difference between the output voltages is used to determine a contact temperature measurement. The ambient temperature sensor 405 (e.g., a thermistor) is used in combination with a look-up table for cold junction compensation of the thermocouple 105. In some embodiments, the thermocouple 105 is operable to detect temperatures in the range of, for example, −40° C. (−40° F.) to 550° C. (1022° F.). The thermocouple may be used independently of the temperature sensor. As such, an output of the thermocouple 105 is not used to compensate or otherwise modify an output of the thermopile. The thermopile is operable to sense a first temperature of a first area in a non-contact manner, and the thermocouple 105 is operable to sense a second temperature of a second area in a contact manner. In some embodiments, the first area and the second area are located on the same object or surface, and the thermocouple 105 can be used in conjunction with the IR temperature sensor 100 to provide, for example, both contact and non-contact temperature measurements of an object. In other embodiments, the first area is located on a first object, and the second area is located on a second object.

The humidity sensor 110 provides a signal to the controller 400 that is indicative of the humidity in the environment surrounding the thermometer 10. The humidity sensor 110 is, for example, a resistive hygrometer which uses a polymer membrane which has a conductivity that varies with the amount of water it absorbs. The humidity sensor 110 is used for calibrating the IR temperature sensor 100 and for compensating measurements made using the IR temperature sensor 100 and the thermocouple 105. In some embodiments, the humidity is displayed on the display 25.

The thermometer 10 also includes a distance-to-spot ratio (“D:S”). The D:S ratio is a ratio of a distance to an object and a diameter of a temperature measurement area (i.e., a spot size). For example, if the D:S is 20:1, the IR temperature sensor 100 averages the temperature of an object twenty feet away over an area with a one-foot diameter. The farther the IR temperature sensor 100 is from the object, the larger the spot size. In some embodiments, the IR temperature sensor 100 includes settings for measuring the temperature of both reflective and non-reflective surfaces.

In some embodiments, the thermometer 10 also includes a distance meter (not shown). The distance meter is, for example, a laser distance meter. The distance meter uses a time-of-flight of a light pulse or an ultrasonic wave to determine a distance to the object. The distance meter measures the time-of-flight required for the light pulse or the ultrasonic wave to travel to the object and back. Based on the time-of-flight and a known speed of light (or sound), the distance to the object is calculated. In other embodiments of the invention, different techniques are used to determine the distance to the object such as a multiple frequency phase-shift technique.

The spot size is calculated using the D:S ratio of the IR temperature sensor 100 and a distance measurement from the distance meter. For example, the distance meter and the IR temperature sensor 100 are aligned along an axis such that the distance meter and the temperature sensor are approximately the same distance from the object. The distance meter uses a single beam of light to determine the distance from the thermometer 10 to the object. The thermometer 10 uses the distance measurement from the distance meter and the D:S ratio to calculate the diameter of a measurement area on the object. The thermometer 10 then displays, for example, a numerical representation of the spot size, an area of the spot, or both. In other embodiments, a visual representation of the measurement area and/or the spot size is displayed.

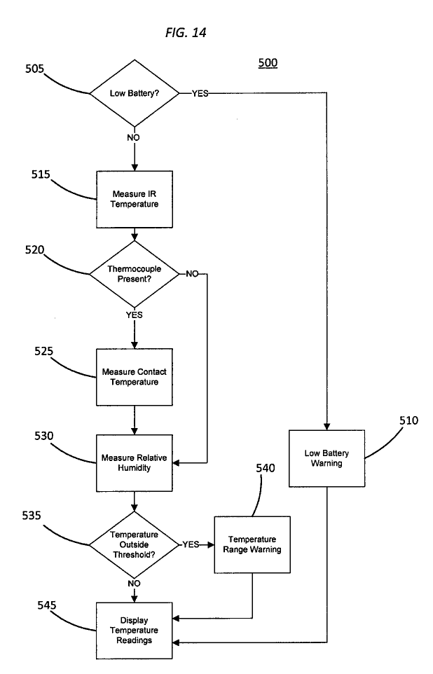

FIG. 14 illustrates a process 500 for taking a temperature measurement using the thermometer 10. The thermometer 10 first determines whether the battery pack 200 is experiencing a low-voltage condition (step 505). If the battery pack 200 is in a low-voltage condition, a low-battery warning is initiated (step 510). In some embodiments, the low-battery warning is displayed on the display 25. In other embodiments, an LED is lighted or a buzzer is sounded to provide the low-battery warning. If no low-voltage condition exists, the thermometer 10 is operable to make temperature measurements. A default operational and display mode for the thermometer 10 is the non-contact temperature measurement mode. To take an IR temperature measurement (step 515), the user engages the trigger 30. Temperature measurements are taken as long as the trigger 30 is engaged. Alternatively, if the electronic trigger lock button 95 is engaged, a continuous temperature measurement can be taken without continuously engaging the trigger 30. The thermometer 10 then determines whether a thermocouple 105 is present (step 520). If a thermocouple 105 is present, a contact temperature measurement is taken (step 525) and the relative humidity is measured using the humidity sensor 110 (step 530). If no thermocouple 105 is present, the thermometer 10 measures the relative humidity using the humidity sensor 110 (step 530). The thermometer 10 then determines whether the measured IR temperature is greater than the high-temperature alarm threshold or below the low temperature alarm threshold (step 535). If the measured IR temperature is outside of the high and low threshold values, a temperature range warning is initiated (step 540). In some embodiments, the temperature range warning is displayed on the display 25. In other embodiments, an LED is lighted or a buzzer is sounded to provide the temperature range warning. If the measured IR temperature is not greater than the high temperature alarm threshold or less than the low temperature alarm threshold, the measured temperature is displayed on the display 25 (step 545).

Thus, the invention provides, among other things, an infrared thermometer that includes an IR temperature sensor, a contact temperature sensor, a humidity sensor, an ambient temperature sensor, a trigger, an LED flashlight, a liquid crystal display, and an easy-to-grip handle portion that allows a user to manipulate and control the thermometer using a single hand. The handle portion is operable to receive a high-voltage removable and rechargeable battery pack, such as a battery pack having a lithium-based chemistry. Various features and advantages of the invention are set forth in the following claims.

What is claimed is:

1. An infrared thermometer configured to receive a removable and rechargeable battery pack, the thermometer comprising:
a main body having a first axis;
a handle having a second axis and including a first recess configured to receive the battery pack, the first recess including at least first and second electrical terminals which are exposed when the battery pack is not inserted into the first recess,
wherein the second axis forms an oblique angle with the first axis, and
wherein the battery pack is inserted into the first recess along the second axis;
an infrared temperature sensor operable to sense a first temperature of a first area in a non-contact manner;
a contact temperature sensor operable to sense a second temperature of a second area in a contact manner; and
a display configured to display an indication of the first temperature and the second temperature.

2. The thermometer of claim 1, wherein the contact temperature sensor and the infrared temperature sensor are independent of one another.

3. The thermometer of claim 1, further comprising an LED flashlight.

4. The thermometer of claim 1, wherein the battery pack is a lithium-ion battery pack.

5. The thermometer of claim 1, further comprising a humidity sensor and an ambient temperature sensor.

6. The thermometer of claim 1, further comprising a trigger operable to initiate an infrared temperature measurement.

7. The thermometer of claim 6, further comprising an electronic trigger lock.

8. The thermometer of claim 1, wherein the first area is located on a first object and the second area is located on a second object.

9. A method of operating an infrared thermometer that includes a handle portion, an infrared temperature sensor, a contact temperature sensor, and a humidity sensor, the method comprising:
powering the infrared thermometer with a removable battery pack inserted into a recess of the handle portion;
sensing, using the infrared temperature sensor, a first temperature of a first area;
sensing, using the contact temperature sensor, a second temperature of a second area;
sensing, using the humidity sensor, a first humidity;
compensating, using an ambient temperature sensor, the first temperature, the second temperature, and the first humidity to generate a compensated first temperature, a compensated second temperature, and a compensated first humidity; and
displaying, on a display, an indication of the compensated first temperature and the compensated second temperature.

10. The method of claim 9, wherein the contact temperature sensor and the infrared temperature sensor are independent of one another.

11. The method of claim 9, further comprising illuminating at least one of the first area and the second area using an LED flashlight.

12. The method of claim 9, wherein the battery pack is a lithium-ion battery pack.

13. The method of claim 9, wherein the first temperature is sensed when a trigger is engaged.

14. The method of claim 13, further comprising locking the trigger electronically.

15. An infrared thermometer configured to receive a removable and rechargeable battery pack, the thermometer comprising:
a main body having a first axis;
a handle having a second axis and including first recess configured to receive the battery pack, the first recess including at least first and second electrical terminals which are exposed when the battery pack is not inserted into the first recess,
wherein the second axis forms an oblique angle with the first axis, and
wherein the battery pack is inserted into the first recess along the second axis;
an infrared temperature sensor operable to sense a first temperature of a first area in a non-contact manner;
a contact temperature sensor operable to sense a second temperature of a second area in a contact manner;
a trigger operable to initiate an infrared temperature measurement;
a flashlight which receives power from the battery pack; and
a display configured to display an indication of the first temperature and the second temperature.

16. The thermometer of claim 15, wherein the contact temperature sensor and the infrared temperature sensor are independent of one another.

17. The thermometer of claim 15, wherein the battery pack is a lithium-ion battery pack.

18. The thermometer of claim 15, further comprising an electronic trigger lock.

19. The thermometer of claim 15, wherein the flashlight is an LED flashlight.

20. The thermometer of claim 15, wherein the first area is located on a first object and the second area is located on a second object.
